(19) United States
(12) Patent Application Publication
(10) Pub. No.: US 2011/0149746 A1
(43) Pub. Date: Jun. 23, 2011

(54) APPARATUS AND METHOD OF MONITORING PACKET STREAM IN ROUTER USING PACKET IDENTITY CHECKING

(75) Inventors: Dong Won Kang, Daejeon (KR); Joon Kyung Lee, Daejeon (KR); Sang Wan Kim, Daejeon (KR); Sang Kil Park, Daejeon (KR); Sang Sik Yoon, Gwangju (KR)

(73) Assignee: Electronics and Telecommunications Research Institute, Daejeon (KR)

(21) Appl. No.: 12/973,801

(22) Filed: Dec. 20, 2010

(30) Foreign Application Priority Data
Dec. 21, 2009 (KR) 10-2009-0128018

(51) Int. Cl. H04L 12/26

(52) U.S. Cl. 370/242

(57) ABSTRACT

Provided is a scheme for extracting and detecting a predetermined traffic packet by monitoring a packet stream in a router, more particularly, a method and apparatus of monitoring a packet stream in a router. The apparatus may include a packet stream reading unit to read a packet stream inputted to the router, and an abnormal packet detecting unit to determine whether the read packet stream is abnormal.

### CROSS-REFERENCE TO RELATED APPLICATION

This application claims the benefit of Korean Patent Application No. 10-2009-0128018, filed on Dec. 21, 2009, in the Korean Intellectual Property Office, the disclosure of which is incorporated herein by reference.

### BACKGROUND

1. Field of the Invention

The present invention relates to a technology for detecting and extracting a predetermined traffic packet, for example, in abnormal traffic in a router, by monitoring a packet stream in the router.

2. Description of the Related Art

Various schemes may extract a desired packet from a currently input packet stream.

Particularly, in a scheme of filtering abnormal traffic, various schemes such as a simple scheme that detects abnormal traffic by determining whether corresponding traffic has a value greater than or equal to a predetermined threshold value, a scheme that detects abnormal traffic based on various complex policies, and the like.

However, the various schemes may have a problem in that the threshold value and the policy generally used regardless of an environment of a targeted network may be restricted.

For example, the technology using the threshold value may continuously require an empirical correction of the threshold value depending on a time and the environment of the targeted network to prevent a false positive.

Due to combinations of various complex policies for relatively recent schemes, the scheme for detecting the abnormal traffic may use policies suitable for a target with respect to the complex policies, based on a network environment, a time, a traffic type, and the like.

### SUMMARY

According to an aspect of the present invention, there is provided an apparatus of monitoring a packet stream in a router, including a packet stream reading unit to read a packet stream inputted to the router, and an abnormal packet detecting unit to determine whether the read packet stream is abnormal.

According to another aspect of the present invention, there is provided a method of monitoring a packet stream in a router, including reading a packet stream inputted to the router, and determining whether the read packet stream is abnormal.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a block diagram illustrating an apparatus of monitoring a packet stream in a router according to an embodiment of the present invention;

FIG. 2 is a flowchart illustrating a method of monitoring a packet stream in a router according to an embodiment of the present invention; and

FIG. 3 though FIG. 5 are flowcharts illustrating methods of determining whether a read packet stream is abnormal according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

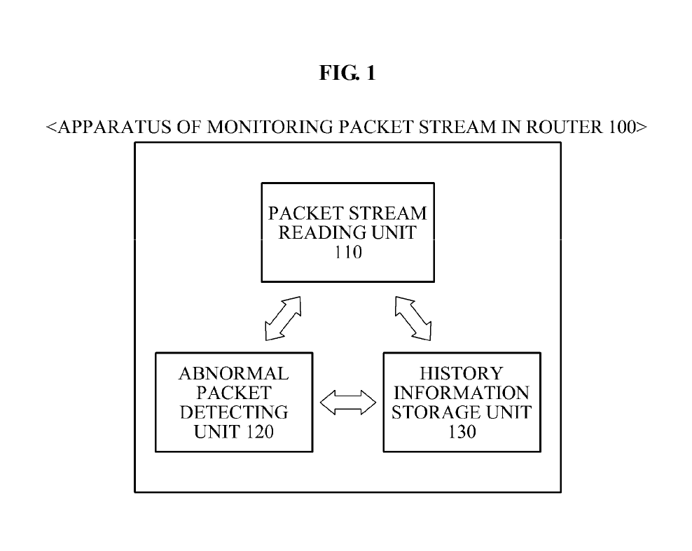

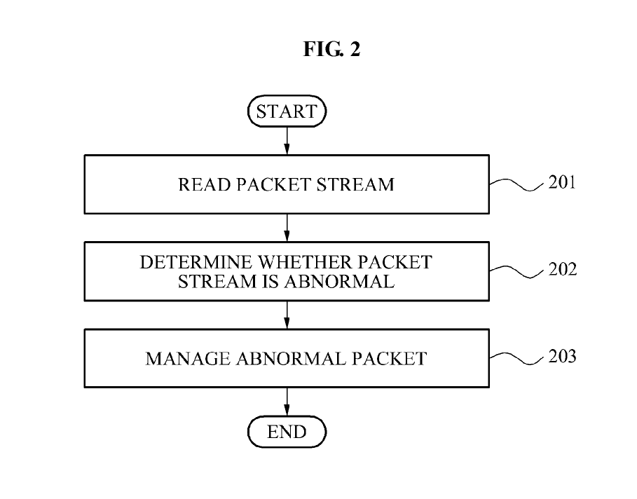

FIG. 1 is a block diagram illustrating an apparatus of monitoring a packet stream in a router 100 according to an embodiment of the present invention.

The apparatus of monitoring a packet stream in a router 100 may include a packet stream reading unit 110 to read a packet stream inputted to the router, and an abnormal packet detecting unit 120 to determine whether the read packet stream is abnormal.

The abnormal packet detecting unit 120 may determine whether the read packet stream is abnormal by verifying history information of a previously inputted and outputted packet stream. The abnormal packet detecting unit 120 may determine whether the read packet stream is abnormal by extracting a traffic considered abnormal from an input and output packet.

The apparatus of monitoring a packet stream in a router 100 may further include a history information storage unit 130 to store history information with respect to the previously inputted and outputted packet stream. The packet stream reading unit 110 may determine whether the same packet as a packet of the history information exists with respect to the read packet stream based on the stored history information, using one of information including source Internet Protocol (IP) address information, destination IP address information, port information, and checksum information, and information including identification information or information including identification information, and Transmission Control Protocol (TCP) Acknowledgement (ACK) information. When the same packet exists, the packet stream reading unit 110 may delete the corresponding history information, and when the same packet does not exist, the packet stream reading unit 110 may add new history information.

Particularly, the abnormal packet detecting unit 120 may determine that stored history information remaining after a predetermined period of time is abnormal, based on the stored history information.

The history information storage unit 130 may store an abnormal packet in a TCP packet or a user datagram protocol (UDP) packet of an Internet Protocol version 4 (IPv4) in the previously inputted and outputted packet stream.

The history information storage unit 130 according to another embodiment of the present invention may generate a hash table with respect to the read packet stream.

The abnormal packet detecting unit 120 according to another embodiment of the present invention may detect, by referring to the generated hash table, a packet not outputted after being inputted to the router.

Since the packet not outputted after being inputted to the router may be an abnormal packet, the abnormal packet detecting unit 120 according to an embodiment of the present invention may determine the packet not outputted in the read packet stream is the abnormal packet.

The abnormal packet detecting unit 120 according to another embodiment of the present invention may detect, by referring to the generated hash table, a packet outputted from the router and not previously inputted to the router.

Since the packet outputted from the router and not previously inputted to the router may be an abnormal packet, the abnormal packet detecting unit 120 according to an embodiment of the present invention may determine the packet not previously inputted to the router in the read packet stream is the abnormal packet.

The abnormal packet detecting unit 120 according to another embodiment of the present invention may monitor a packet stream read by the packet stream reading unit 110 to detect a packet not outputted after being inputted to the router or a packet outputted from the router and not previously inputted to the router, and determine the corresponding packet is an abnormal packet.

The determined abnormal packet may be variously analyzed and managed. For example, the determined abnormal packet may be managed by a process of adding a system start time to packet data transferred from an OCTEON core, a process of indicating, on a console, simple statistics with respect to the received packet data and statistical data transferred from the OCTEON core, and storing the packet data in a packet capture (PCAP) form, and the like.

Thus, according to an embodiment of the present invention, regardless of an environment of a network where a router is located, by consistently providing data narrowing an extent of traffic considered to be abnormal in existing router traffic, maintenance costs may be reduced, and basic data for a prompt response through more rapid and accurate abnormal traffic detection may be provided.

According to an embodiment of the present invention, since only predetermined information included in a packet is used for an identity determination corresponding to a core in technology, adequate filtering may be performed in a high-speed (Gbps) traffic environment, and the abnormal traffic in the router may be analyzed. In addition, a traffic induction according to a router action characteristic and an erroneous setting of the router may be analyzed.

FIG. 2 is a flowchart illustrating a method of monitoring a packet stream in a router according to an embodiment of the present invention.

Referring to FIG. 2, in operation 201, the method may read the packet stream inputted to the router.

In operation 202, the method may determine whether the read packet stream is abnormal. In operation 203, the method may manage a packet determined to be abnormal based on a selected criteria.

The method of monitoring a packet stream in a router according to an embodiment of the present invention may determine whether the packet stream is abnormal by analyzing each packet configuring the read packet stream. A packet determined to be normal may be forwarded via a selected route using the router, and a packet determined to be abnormal may be managed based on the selected criteria.

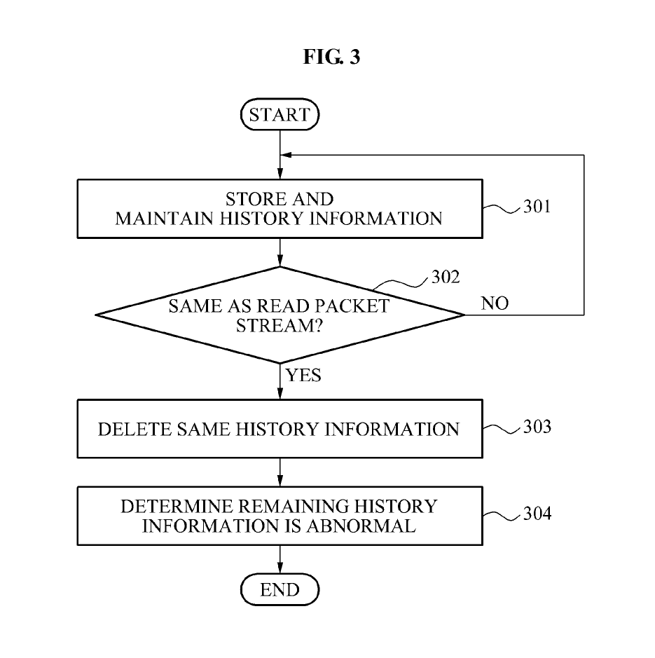

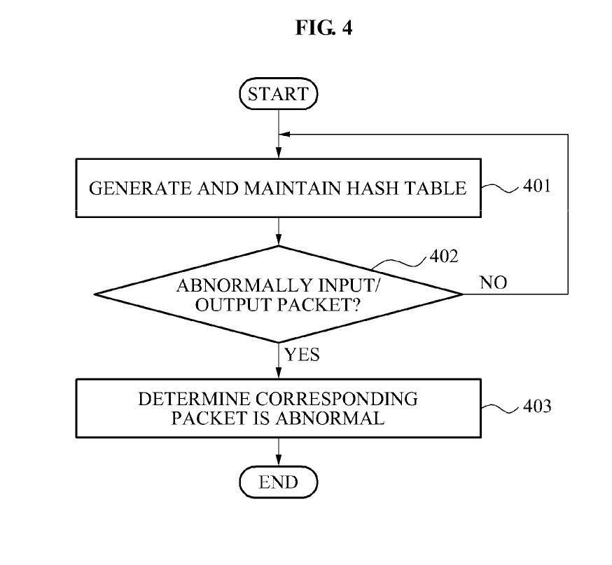

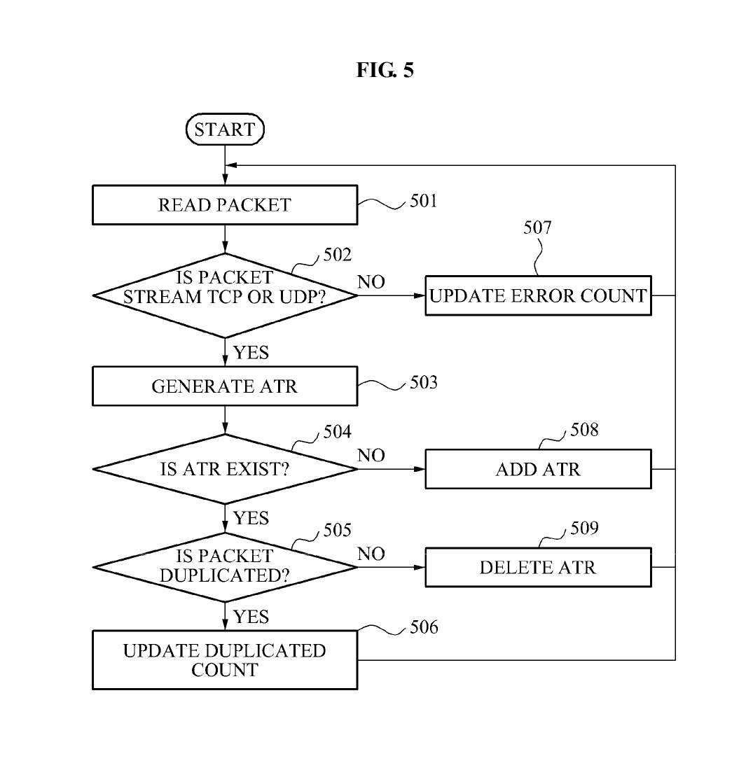

Hereinafter, referring to FIG. 3 through FIG. 5, various embodiments for detecting or determining an abnormal packet, using a method of monitoring a packet stream in a router according to an embodiment of the present invention, will be described.

FIG. 3 though FIG. 5 are flowcharts illustrating methods of determining whether a read packet stream is abnormal according to an embodiment of the present invention.

Referring to FIG. 3, in operation 301, the method may include storing and maintaining history information with respect to a previously inputted and outputted packet stream.

In operation 302, to determine whether the packet stream is abnormal, the method may include determining whether the read packet stream is the same as a previously inputted packet stream, that is, may determine whether each packet configuring the read packet stream is the same as a packet stored as the history information.

In operation 303, when each packet configuring the read packet stream is the same as the packet stored as the history information, the corresponding packet may be determined to be normal, and may be deleted from the history information. When the same packet as the packet stored as the history information does not exist, the corresponding packet may be added as new history information.

In operation 304, the method may include determining remaining history information is abnormal.

Referring to FIG. 4, in operation 401, a method of monitoring a packet stream in a router according to an embodiment of the present invention may include generating and maintaining a hash table with respect to a previously inputted and outputted packet stream.

In operation 402, to determine whether the packet stream is abnormal, the method may include detecting abnormally inputted and outputted packet in the read packet stream.

For example, the method may include detecting, by referring to the hash table, a packet not outputted after being inputted to the router, or a packet outputted from the router and not previously inputted to the router. When an input and output of the same packet does not exist after a predetermined period of time, the method may consider the traffic abnormal.

In operation 403, the detected packet may be determined to be an abnormal packet.

For example, when a packet exists in the hash table after a predetermined period of time as a result of retrieving the hash table, the corresponding packet may be considered abnormal.

The packet determined to be abnormal may be periodically transmitted to a predetermined host.

Referring to FIG. 5, in operation 501, a method of monitoring a packet stream in a router according to an embodiment of the present invention may include reading the packet stream.

In operation 502, since whether the packet stream is abnormal may be detected only with respect to a TCP packet or a UDP packet of an IPv4, the method may include determining whether the packet stream is the TCP packet or the UDP packet.

In operation 503, when the packet stream corresponds to the TCP packet or the UDP packet, the method may include generating an Anomaly Traffic Record (ATR) with respect to the TCP packet or the UDP packet of the IPv4.

In operation 504, the method may include determining whether the ATR exists. In operation 505, when the ATR exists, the method may include determining whether the packet included in the read packet stream is duplicated.

In this instance, the method may determine whether the same packet exists based on a 5-tuple (src/dst ip address, src/dst port, protocol), using one of TCP, UDP, checksum, identification and identification+ack, and may determine the packet is duplicated when the same packet exists.

In operation 506, as a result of determination in operation 505, the method may include updating a duplicated count when the packet is duplicated, and may return to operation 501 of reading a new packet after a predetermined period.

In operation 507, when the packet stream does not correspond to the TCP or the UDP packet in operation 502, the method may include updating an error count, and may return to operation 501 of reading a new packet after a predetermined period.

In operation 508, when the ATR does not exist in operation 504, the method may include adding the ATR, and may return to operation 501 of reading a new packet after a predetermined period.

In operation 509, when the packet is not duplicated as a result of the determination in operation 505, the method may include deleting the generated ATR, and may return to operation 501 of reading a new packet after a predetermined period.

When the same packet does not exist, the method may include generating ATR data with a current packet, and when the same packet exists, the method may include determining whether the packet is a duplicate of the existing packet, and when the packet is a duplicate of the existing packet, the method may include updating a duplicated count, and when the packet is not duplicated with the existing packet, the method may include deleting the ATR.

Using the method of monitoring a packet stream in a router according to an embodiment of the present invention, maintenance costs may be reduced, and an abnormal packet may be detected more rapidly and accurately by consistently providing data in which an extent of traffic considered to be abnormal in an existing router traffic is narrowed, regardless of an environment of a network where a router is located.

According to an embodiment of the present invention, maintenance costs may be reduced, and basic data for a prompt response through more rapid and accurate abnormal traffic detection may be provided by consistently providing data in which an extent of traffic considered to be abnormal in an existing router traffic is narrowed, regardless of an environment of a network where a router is located.

According to an embodiment of the present invention, since predetermined information included in a packet is used for an identity determination corresponding to a core in technology, adequate filtering may be performed in a high-speed (Gbps) traffic environment.

According to an embodiment of the present invention, an analysis on the abnormal traffic in the router, and a traffic induction due to a router action characteristic and an erroneous setting of the router may be performed.

According to an embodiment of the present invention, in a management of an IP network, an abnormal traffic induction may be detected only with an octet value and packet number, not requiring any system investment cost.

According to an embodiment of the present invention, more reliable detection may be performed by subdividing an extent and detecting a traffic considered abnormal in a packet unit.

The above-described method of monitoring a packet stream in a router according to an embodiment of the present invention may be recorded in non-transitory computer-readable media including program instructions to implement various operations embodied by a computer. The media may also include, alone or in combination with the program instructions, data files, data structures, and the like. Examples of non-transitory computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. An apparatus of monitoring a packet stream in a router, comprising:
a packet stream reading unit to read a packet stream inputted to the router; and
an abnormal packet detecting unit to determine whether the read packet stream is abnormal.

2. The apparatus of claim 1, wherein the abnormal packet detecting unit determines whether the read packet stream is abnormal by verifying history information of a previously inputted and outputted packet stream.

3. The apparatus of claim 1, further comprising:
a history information storage unit to store history information with respect to the previously inputted and outputted packet stream,
wherein the packet stream reading unit determines whether the same packet as a packet of the history information exists with respect to the read packet stream based on the stored history information, and when the same packet exists, the packet stream reading unit deletes the corresponding history information, and when the same packet does not exist, the packet stream reading unit adds new history information, and
the abnormal packet detecting unit determines that the remaining history information existing after a predetermined period of time is abnormal, based on the stored history information.

4. The apparatus of claim 3, wherein the packet stream reading unit determines whether the same packet as a packet of the history information exists, based on at least one of source Internet Protocol (IP) address information, destination IP address information, port information, checksum information, identification information, and information including identification information and Transmission Control Protocol (TCP) Acknowledgement (ACK) information.

5. The apparatus of claim 4, wherein:
the history information storage unit stores an abnormal packet in a TCP packet or a user datagram protocol (UDP) packet of an Internet Protocol version 4 (IPv4) in the previously inputted and outputted packet stream, and
the packet stream reading unit determines whether the same packet as a packet of the history information exists with respect to the stored abnormal packet and the read packet stream, based on at least one of the source IP address information, the destination IP address information, the port information, the checksum information, the identification information, and ACK information.

6. The apparatus of claim 4, wherein:
the history information storage unit generates a hash table with respect to the read packet stream, and
the abnormal packet detecting unit detects, by referring to the generated hash table, a packet not outputted after being inputted to the router, and determines the detected packet is the abnormal packet.

7. The apparatus of claim 4, wherein:
the history information storage unit generates a hash table with respect to the read packet stream, and
the abnormal packet detecting unit detects, by referring to the generated hash table, a packet outputted from the router and not previously inputted to the router, and determines the detected packet is the abnormal packet.

8. A method of monitoring a packet stream in a router, comprising:
reading a packet stream inputted to the router; and
determining whether the read packet stream is abnormal.

9. The method of claim 8, further comprising:
storing history information with respect to the previously inputted and outputted packet stream,
wherein the determining comprises determining whether the read packet stream is the same as the previously inputted packet stream based on the stored history information, and
determining the read packet stream is abnormal when the read packet stream is determined to be the same as the previously inputted packet stream.

10. The method of claim 8, further comprising:
generating a hash table with respect to the read packet stream,
wherein the determining comprises:
detecting, by referring to the generated hash table, a packet not outputted after being inputted to the router, or a packet outputted from the router and not previously inputted to the router, and
determining the detected packet is the abnormal packet.
